(19) United States
(12) Patent Application Publication
(10) Pub. No.: US 2006/0110312 A1
(43) Pub. Date: May 25, 2006

(54) Bromide reduction process in liquid solutions

(76) Inventors: Gerald Ziegenbalg, Freiberg (DE); Harald Liebe, Regina (CA); Murray Schultz, Regina (CA)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/999,817

(22) Filed: Nov. 30, 2004

(30) Foreign Application Priority Data
Nov. 23, 2004 (CA) 2,488,180

(51) Int. Cl. C01B 11/20

(52) U.S. Cl. 423/499.1; 423/473

(57) ABSTRACT

The invention provides a method for reducing bromine levels in brine solutions such as potassium chloride brine solutions. Bromide in solution is converted to hypobromite by the addition of an oxidant such as sodium hypochlorite. Hypobromite is precipitated by the addition of a metal cation such as magnesium under conditions of basic pH. The process is pH dependent such that the most efficient removal of bromine is achieved at a sodium hydroxide concentration of 90-200 mM. The pH optimum is also temperature dependent such that increased temperature lowers the optimal pH for bromide removal. The invention further provides a bromine-reduced potassium chloride product, suitable for uses in industrial applications. By the method of the invention bromine levels in a potassium chloride feed stock can be reduced by 97% or more.

### FIELD

This invention is in the field of brine processing, and in particular the field of removing undesired impurities such as bromide from brine solutions such as those used in the production of potash products.

### BACKGROUND

Potash is formed by the evaporation of salt water, such as seawater. The world's potash deposits exist in locations once covered by inland seas that have since evaporated, leaving behind their salt constituents. The predominant inorganic ions present in seawater are sodium, chlorine, magnesium, sulfur, potassium, calcium and bromine.

Mining of potash is performed in a number of ways, including conventional mining and solution mining techniques. The post-processing mining of potash ore feed typically involves dissolving the crude potash, removing insoluble impurities such as clays and then purifying the KCl from NaCl through a recrystallization process. While the recrystallization techniques are relatively effective at removing insoluble contaminants, and separating KCl from NaCl, the effectiveness of the technique in removing some other unwanted soluble components such as bromide is less effective. Depending on the end use to which the finished potash product is put, constituents other than potassium and chloride can be problematic, and potentially even render potash unfit for use in certain applications.

Potash is used in a variety of applications. The most common use is as an agricultural fertilizer. Potassium has been used as a fertilizer for hundreds of years, and in combination with the appropriate amounts of phosphate and nitrogen, is an important constituent in plant growth. Roughly 95% of the world's potash production goes into fertilizer, with the remainder used in other commercial and industrial products. Since the early 1960's the increasing use of potash in fertilizers has been an important tool in developing countries, where increasing demands on limited agricultural outputs has increased the desire for improved yields of traditional agricultural products. Currently, nearly half the world's fertilizer consumption occurs in developing nations in Asia.

Potash is also used in a variety of non-agricultural applications as well. These include use as a recycling flux in the aluminum industry and in the production of chlorine. A significant demand for chlorine is for the production of chlorinated products used in the treatment of drinking water to inactivate pathogenic organisms such as bacteria, parasites and viruses. Chlorine is also used as a basic molecular building block for the production of plastics and in the manufacture of pharmaceutical products. Over one-third of all chlorine produced annually goes into the manufacture of polyvinylchloride (PVC), a common material used in building construction.

Potassium chloride has other uses as well. One of the major developments over the last 150 years has been the advent of clean, safe drinking water, and water treatment with chemical antiseptics has been an important contribution to human health. One source of chloride ions commonly used in the chemical industry for the production of chlorine-containing water treatment products is potassium hydroxide (KOH) produced from KCl. Because bromine, like chlorine, is also a halogen, the two molecules share similar chemical properties. Consequently, processes designed to produce chlorinated compounds will also produce brominated ones as well, should bromine be present in the starting material from which the chloride is derived.

This presence of bromine in a product can be problematic, as brominated impurities in chlorine water treatment products are known to produce disinfection by-products (DBP's) when used in water treatment applications. These halogenated by-products are formed when natural organic material in a water source reacts with free chlorine or bromine. Many of these halogenated organic by-products, including brominated by-products are known or suspected to be carcinogens. Because of the potential health risk posed by DBP's, the U.S. Environmental Protection Agency has established limits for the amounts of bromine that will be permissible in treated drinking water destined for human consumption as a means of reducing the exposure of humans to these compounds (EPA Bulletin 815-F-98-010, December 1998), with a deadline for compliance of January 2004. As a result, the presence of bromine in KCl presents a problem where it is desired to use the KCl in industrial application such as the production of chlorine. Even in naturally occurring sources of salt such as seawater, the bromine component accounts for 1900 ppm once the water is removed and a crystalline product produced. Bromine contents in potash deposits are similar due to the fact that potash deposits are the result of the prehistoric evaporation of what once were inland seas with salt compositions similar to that of present-day seawater.

### SUMMARY OF THE INVENTION

It is an object of the present invention to provide a method for removing bromide from brine solutions. It is a further object of the present invention to provide such a method of removing bromide from brine solutions used in the manufacture of potash products.

The invention provides in a first embodiment, a method of reducing bromide concentration in a potassium chloride feed brine solution. The method comprises adding an amount of a divalent metal cation effective to precipitate hypobromite, adding an amount of an oxidant effective to convert bromide to hypobromite, adjusting the pH of the brine solution to an effective pH that favors precipitation of hypobromite and removing the bromide-containing precipitate to yield a reduced-bromine brine solution.

Conveniently, an oxidant such as sodium hypochlorite (common bleach), at a stoichiometry of 1.5 to 3.0:1 molar parts oxidant relative to initial bromide concentration is effective in reducing the levels of bromide remaining in solution after a potassium chloride feed brine solution is treated by the method of the invention.

The method can comprise the addition of a metal cation under conditions of basic pH. Conveniently, the metal cation may be supplied in the form of magnesium chloride, and its addition results in the formation of a magnesium-hydroxide-bromine precipitate. In this way bromide can be selectively removed from the brine solution by filtration, centrifugation or by using other methods for removing precipitates from solutions that are well known in the art such as settling tanks and the like. Alternatively, the addition of a flocculant allows the bromide containing precipitate to be removed by flotation separation or sinking methods.

The formation of magnesium precipitates is sensitive to pH such that precipitation takes place most effectively in a limited pH range, typically in the range of pH 9-12. Thus, the method of the present invention also discloses an optimal hydroxide concentration in order to provide the optimal pH giving the most effective removal of bromide from a potash brine solution. Conveniently, the hydroxide is added in the form of NaOH, such that at a concentration of approximately 95 millimolar (mM) NaOH, the most effective removal of bromide is achieved by the method of the invention. The optimal amounts of magnesium and hydroxide to add for the most efficient removal of bromine will depend on the chemical composition of the input brine feed. However, using the method of the invention, one can readily determine the optimal conditions for bromine removal without undue experimentation. At concentrations of NaOH greater or less than the optimal amount, the effectiveness of bromide removal is reduced, and thus the method of the invention further provides a most effective hydroxide concentration for optimal removal of bromide from feed brine.

The optimal pH for bromide removal also varies inversely with the temperature. Performing the process at higher temperature lowers the pH at which maximal removal of bromide is achieved. Since the energy required for heating and cooling of brines during potash processing can significantly add to the cost of production, the method provides a process adaptable for use in commercial facilities to take advantage of process temperatures that are most advantageous at a particular refining site, keeping costs of producing reduced bromide potassium chloride at a minimum. By sensing the temperature of the brine prior to the process, it is therefore possible to determine in advance the optimal pH at which to carry out the method of the invention.

The results have also shown that performing the method of the invention at higher temperature results in greater removal of bromide from the potassium chloride feed brine solution. As a result, where it is desired to have further reduction in bromide levels, adjusting the temperature to higher temperatures may provide an additional advantage in terms of bromide removal.

The invention provides in a second embodiment, a bromine-reduced potassium chloride product produced in a potash mining process wherein the bromine-reduced potassium chloride product comprises less than 100 ppm bromine. Conveniently, the bromine reduced potassium chloride product is recovered from the potassium chloride feed brine solution by methods well known in the art. These include differential precipitation and forced evaporation and baffled crystallization, as well as the use of a hydrocyclone. By adjusting the concentration of divalent metal cation, pH and temperature of the potassium chloride brine solution as described in the provided examples, it is possible to achieve a bromine reduced potassium chloride product with less than 15 ppm bromine.

Alternatively, where low bromine levels in the finished salt product are not required, the method of the invention is easily adaptable to yield a finished salt product with greater than 100 ppm as well. Moreover, while the examples included herein demonstrate the utility of the invention in reducing bromine content in finished potash products, it is anticipated that the method of the invention could be readily adapted for use in reducing bromine content of other types of brine solutions, for example in NaCl brines.

In a third embodiment the invention provides an apparatus for producing a bromine-reduced potassium chloride brine solution. The apparatus comprises a means for adding a divalent metal cation to a potassium chloride brine solution in a concentration effective to precipitate hypobromite, a means for adding an oxidant to the potassium chloride brine solution in a concentration effective to convert substantially all of the bromide in the potassium chloride feed brine to hypobromite, a pH sensing and control system to maintain the pH of the process at an effective pH that favors the precipitation of hypobromite by the divalent metal cation and a means for removing a bromide precipitate to yield a bromine-reduced potassium chloride brine solution.

Conveniently, the starting material, or feed brine, used in the method of the invention may be either a raw brine feed such as that produced during the solution mining process, or crystallizer overflow, which is an intermediate produced during the refining of potash. By providing a means for adding a divalent metal cation, an oxidant and by adjusting pH within an effective range of pH 9-12, the apparatus results in the formation of a bromide containing precipitate in the potassium chloride feed brine. Where the metal cation used is calcium, experiments have shown that pH>12 are compatible with the method. It is also anticipated that other metal cations such as iron and manganese would work equally as well in the method as described herein.

As the optimal pH for precipitation of bromide is shown to vary with temperature, by further providing a means of sensing the temperature of the potassium chloride feed brine solution, it is possible to predict in advance an optimal pH such that a maximal amount of bromide will be precipitated from the feed brine solution. While the apparatus can conveniently process the potassium chloride feed brine at temperatures in the range of 40°-185° F., the most effective removal of bromide occurs at a temperature of 140° F. and an optimal pH in the range of 9-9.5.

The use of temperatures and lower optimal pH may also be possible, but the increased production costs due to energy used in heating the feed brine to higher temperature would make such higher temperatures less desirable. Regardless there may be situations where very low bromide content justifies the added costs of production, and so the invention anticipates the use of temperatures outside the range of temperatures that have been experimentally tested, as well as different metal cations and amounts of reactants.

In this way the present invention provides a method and apparatus of producing a reduced bromide KCl product wherein the bromide levels are reduced by nearly 40-fold. The resulting KCl product is suitable for use in industrial applications where contamination of KCl with bromide is of concern.

### DESCRIPTION OF THE DRAWINGS

While the invention is claimed in the concluding portions hereof, preferred embodiments are provided in the accompanying detailed description which may be best understood in conjunction with the accompanying diagrams where:

FIG. 1: Final bromide concentrations in raw feed brine after the addition of different amounts of 10% NaOCI (sodium hypochlorite) solution. Sodium hydroxide (NaOH) was present at 50 mM;

FIG. 2: Bromide concentrations in raw feed brine as a function of NaOH concentration. Sodium hypochlorite concentration was 1.2 mM;

FIG. 3: Bromide concentrations in crystallizer overflow as a function of NaOCl concentration. Sodium hydroxide concentration was 93.75 mM.

FIG. 4: Final bromide concentrations in crystallizer overflow as a function of NaOH concentration. Sodium hypochlorite concentration was 4.9 mM.

FIG. 5: Final bromide concentrations in crystallizer overflow as a function of NaOH concentration. Sodium hypochlorite concentration was 9.25 mM.

FIG. 6: Final bromide concentrations in crystallizer overflow as a function of NaOCl concentration. Sodium hydroxide concentration was 187.5 mM.

FIG. 7: Effect of temperature on the pH optimum for bromide removal. Increasing temperature reduces the pH necessary for maximal removal of bromide from a potassium chloride brine solution.

FIG. 8: A flow diagram of one embodiment of a production circuit for making a bromine-reduced potassium chloride product.

### DETAILED DESCRIPTION OF THE ILLUSTRATED EMBODIMENTS

The present invention provides a method for reducing bromide concentrations in brine solutions. In particular, the method is adaptable to the processing of potash brine solutions in order to manufacture a potassium chloride product with reduced bromide content. The following examples are intended to be illustrative of the present invention and to teach one of ordinary skill how to practice the method of the invention. These examples are not intended to limit the invention or its protection in any way.

### EXAMPLES

Preliminary investigations showed that bromide in concentrated KCl solutions could be removed by the addition of sodium hypochlorite (NaOCl), which functions as an oxidant, to convert bromide to hypobromite. It is commonly known in the field of physical chemistry that hypobromite can then be precipitated together with magnesium and hydroxide. The reactions are as follows:
Br⁻+OCl⁻→Cl⁻+OBr⁻ Reaction 1:
Mg²⁺+OH⁻+OBr—→Mg(OH, Br) Reaction 2:
However, what has not been described previously is a method by which bromide can be removed under alkaline conditions from potash feed brine.

Experimental studies indicated that bromide could be removed from a potash brine and by oxidation in the presence of a divalent cation such as magnesium. As a result, additional experiments were performed in order to better understand the chemical principles involved as well as to optimize the process. In particular the experiments were designed to determine the amount of oxidant necessary to convert bromide to hypobromite, whether alternative oxidants such as hydrogen peroxide of calcium hypochlorite would work within the method of the invention, the influence of divalent cation concentration on the process, and the most favourable pH for precipitation of bromide by magnesium and hydroxide. In addition, the effect of temperature on the efficiency of bromide removal was also explored. The results of these investigations are presented below.

Experimental Details

Source of Feed Brine Solution:

The experimental investigations performed in demonstrating the practice of the invention were performed using potash brine derived from the standard solution mining process materials practiced in the IMC potash mine at Belle Plaine Saskatchewan. All initial investigations were carried out at room temperature without any changes in the composition of the original solution. The starting solution had a density of 1.22 gm/mL and a pH of 12. Experiments were carried out using sample volumes of 100 mL.

Solution Characteristics:

Two types of feed brine solutions were used in the studies; one a raw feed brine and the other a crystallizer overflow solution. The characteristics of the two solutions with respect to bromide, magnesium chloride and calcium chloride were:

| Solution | Br— | MgCl₂ | CaCl₂ |
|---|---|---|---|
| Raw Feed Brine | 212 ppm | 31 mM | 36 mM |
| Crystallizer Overflow | 376 ppm | 59 mM | 49 mM |

Oxidants:

In initial experiments a sodium hypochlorite (NaOCl) solution (10% by weight) was used as the oxidant. It is anticipated, based on similar chemical properties, that other oxidants, such as ozone, H₂O₂ and CaOCl₂ could also be used in practicing the method of the present invention. Natural oxidation, as could be achieved by aeration of the brine solution, would also be compatible with the method.

General Methods:

A 10% NaOCI solution was added to 200 mL of potash solution and stirred for 20 min. Samples were then taken for analysis of the bromide content. Solids were separated from the solution by centrifugation and a sample of the supernatant was analyzed for bromide, calcium and magnesium content. It was noted that the oxidation reaction (Reaction 1) was very rapid and a time dependency could not be demonstrated.

To determine bromide levels, the following iodometric method was used, based on the knowledge that in a slightly acidic solution, bromide is oxidized to bromate which in the presence of iodide and acid results in the following reactions:
BrO₃⁻+9I⁻+6H⁺→3I₃⁻+Br⁻+3H₂ Reaction 3:
I₃⁻+2S₂O₃²⁻→3I⁻+S₄O₆²⁻ Reaction 4:
Magnesium and calcium levels were determined by titration with 0.1M EDTA.
Results:

### Example 1

### Raw Feed Brine

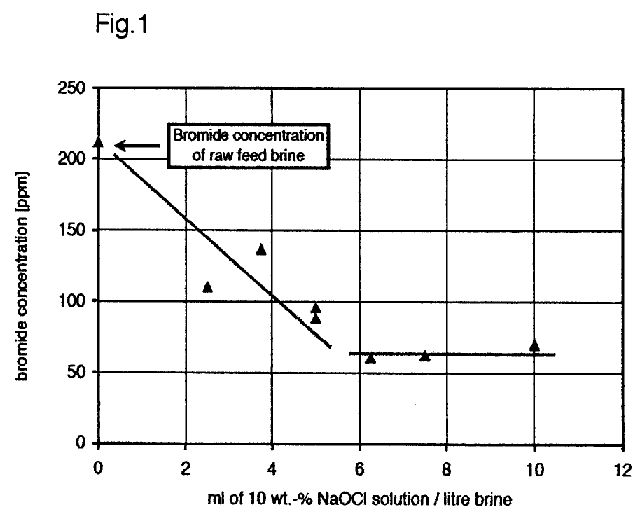

Initial bromide levels in raw feed brine were 212 ppm. As shown in FIG. 1, increasing the amount of oxidant (up to 6 mL 10% NaOCl per L of raw feed brine; 167 mM final concentration) to raw feed brine resulted in a decrease in bromide levels to approximately 60 ppm. Addition of more than 6 mL of the oxidant solution to 1 L of the raw feed brine (i.e. NaOCl levels>170 mM) produced no further reduction in bromide levels, indicating that all the bromide has been converted to hypobromite. In this experiment, NaOH levels were constant at 50 mM. Under these conditions, the stoichiometry of the process is such that hypochlorite: bromide ratios of 1.5 to 2.5:1 are most favourable.

The role of magnesium concentration in the debromination process was also investigated. As shown in Tables 1 and 2, the data indicate that increasing magnesium concentrations leads to a decrease in final bromide concentration. To 1 L of raw feed brine were added 5 mL of 10% NaOCl, 25 mL of 2 molar (M) NaOH and either no magnesium chloride or 30 mL of 4M MgCl₂. In the absence of added MgCl₂, final bromide concentration was 96 ppm, whereas with the addition of MgCl₂ (120 mM final concentration) final bromide concentration was reduced to 53 ppm, despite the fact that NaOCl and NaOH concentrations were constant (Table 1). Therefore, by adding hypochlorite but no additional magnesium, a reduction in bromine to less than 100 pm was achieved. Bromine levels could be further decreased to less than 60 ppm by the addition of magnesium (Table 1). It was also observed that in the presence of constant levels of NaOCl and MgCl₂, that increasing NaOH concentration resulted in a reduction in final bromide concentration (Table 2). The data clearly show that addition of a divalent cation in the form of magnesium increases the amount of bromide removed from the feed brine solution.

TABLE 1
Influence of magnesium concentration on the
final bromide content of raw feed brine.

| | Volume of | Volume of | | | |
|---|---|---|---|---|---|
| Volume | added | added 2 | Volume of | | |
| of | 10 wt.-% | molar | added 4 molar | | Final bromide |
| brine | NaOCl | NaOH | MgCl₂ | | concentration |
| 1000 ml | 5 ml | 25 ml | 0 | ml | 96 ppm |
| 1000 ml | 5 ml | 25 ml | 30 | ml | 53 ppm |

TABLE 2
Effect of NaOH concentration on final bromide content of raw feed
brine, in the presence of constant levels of NaOCl and MgCl₂.

| | Volume of | Volume of | | |
|---|---|---|---|---|
| Volume | added | added 2 | Volume of | |
| of | 10 wt.-% | molar | added 4 molar | Final bromide |
| brine | NaOCl | NaOH | MgCl₂ | concentration |
| 1000 ml | 5 ml | 12.5 ml | 30 ml | 93 ppm |
| 1000 ml | 5 ml | 25.0 ml | 30 ml | 52 ppm |
| 1000 ml | 5 ml | 50.0 ml | 30 ml | 47 ppm |

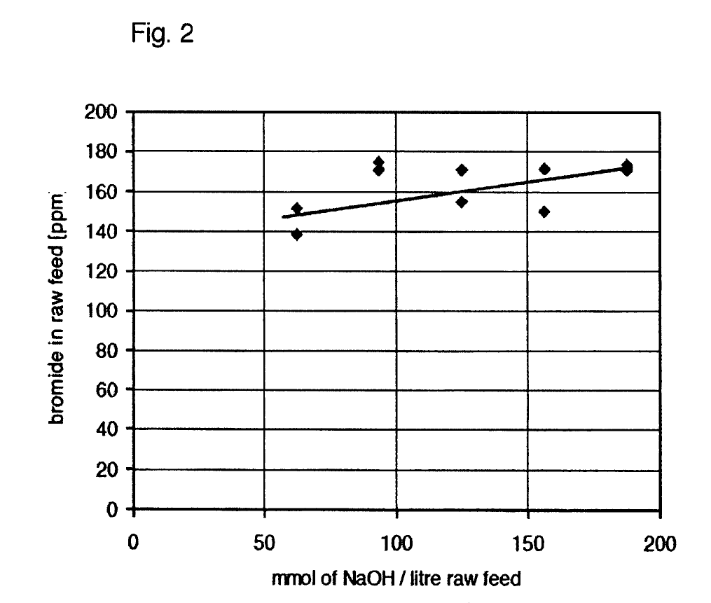

In evaluating this response, it was noted that within the range of NaOH concentrations that were tested, no over dosage of NaOH was observed. It was assumed based on established physical chemical principles that the addition of NaOH, in the presence of sufficient MgCl₂ leads to the precipitation of Mg(OH)₂, and a resulting pH levels of approximately 10. When all the magnesium is precipitated, pH levels increase to 12-13. However, at these higher pH levels it was discovered that final bromide concentrations remained high, indicating that at higher pH bromide removal was less effective (FIG. 2) consistent with the interpretation that at pH>12 hydroxide over dosage does occur.). The data indicated that the formation of Mg(OH)(OBr) takes place in a limited pH interval.

### Example 2

### Crystallizer Overflow

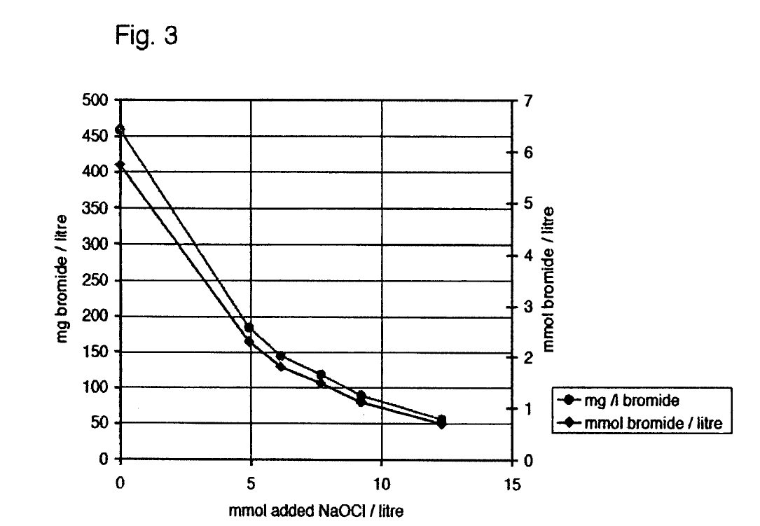

Experiments using crystallizer overflow in place of raw feed brine have led to similar conclusions. The addition of 5 mL of 10% NaOCl resulted in a reduction of final bromide concentration from an initial value of 377 ppm to 80 ppm (Table 3 and FIG. 3).

TABLE 3
Bromide reduction in crystallizer overflow.

| | | | | Volume of | | |
|---|---|---|---|---|---|---|
| Volume | Volume of added | | Volume of | added 4 | Final bromide | |
| of | 10 wt.-% NaOCl | | added 2 | molar | concentration | |
| brine | ml | mmol | molar NaOH | MgCl₂ | ppm | mg/l |
| 1000 ml | 2.5 | 3.88 | 50.0 ml | 0 ml | 217 | 264 |
| 1000 ml | 3.75 | 5.81 | 50.0 ml | 0 ml | 117 | 143 |
| 1000 ml | 5 | 7.75 | 50.0 ml | 0 ml | 82 | 101 |

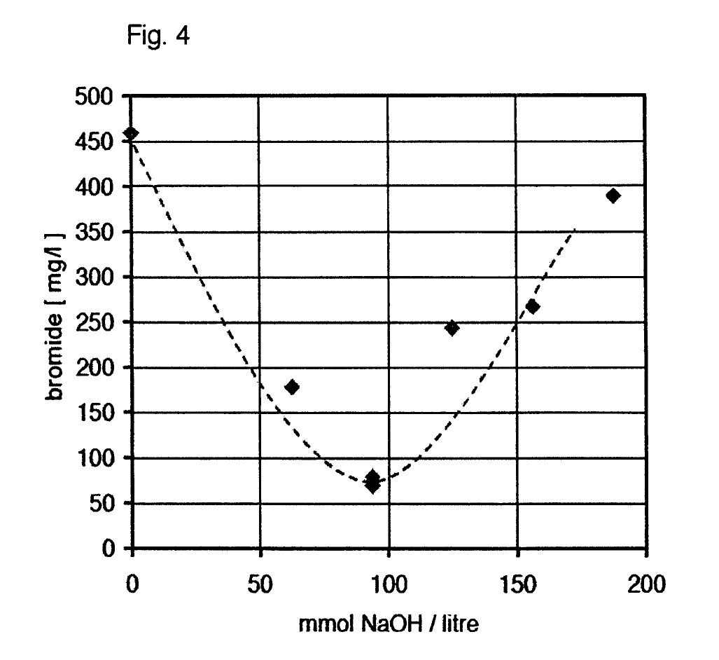

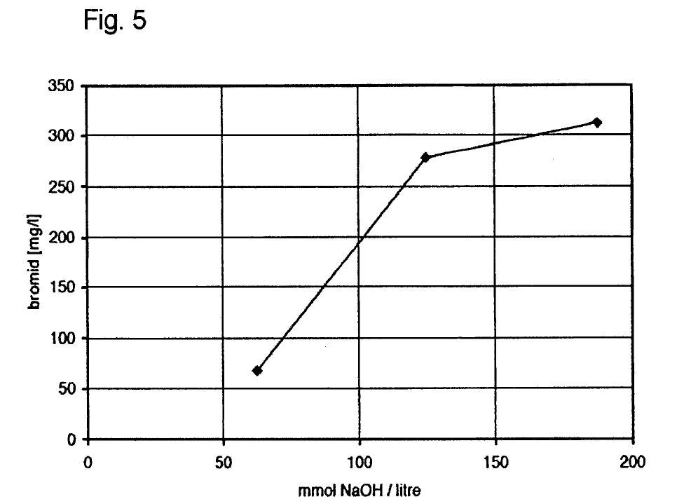

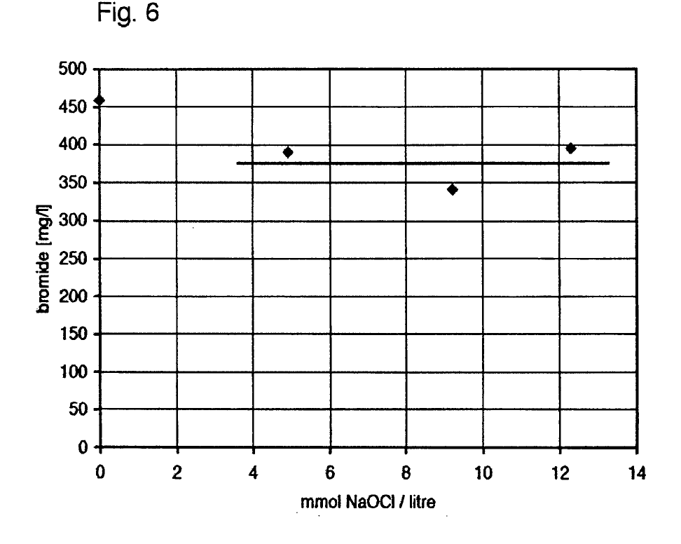

Since the results with raw feed brine solution suggested that the pH of the solution was an important determinant of the extent to which final bromide concentration could be reduced, additional experiments were performed to better assess the effect of adding NaOH. In the presence of understoichiometric levels of NaOCl (i.e. less hypochlorite than would be needed to completely convert all the bromide into hypobromite—see Reaction 1), it was observed that there is a NaOH optimum of approximately 95 mM. Sodium hydroxide concentrations, less than or greater than this amount, reduced the effectiveness of the bromide removal process (FIG. 4), as did over dosage with NaOH (FIG. 5). Importantly, if NaOH concentrations are too high, the efficiency of bromide removal is reduced (FIG. 6).

At a pH of around 10, the solutions contain CaCl₂. It appears that only small amounts of calcium are incorporated into the magnesium hydroxide precipitate as evidenced by the fact that calcium levels in the solution after the addition of NaOH (5.1 gm/L calcium) are comparable to the starting calcium concentration in the crystallizer overflow solution (5.4 gm/L). In contrast, magnesium concentration is reduced from 5.62 gm/L to 0.428 gm/L under these same conditions. However, at a pH greater than 12.5 it appears that nearly all the calcium is precipitated, resulting in nearly calcium-free solution at these higher pH conditions, indicating that calcium may also be effective as a divalent cation capable of forming a precipitate with bromine.

It was further discovered that increasing the magnesium concentration by adding MgCl₂ resulted in an increase in Mg(OH, Br) precipitation (Table 4). It is possible to produce solutions in which bromide concentration has been reduced by nearly 40 fold from the original solution and bromine concentrations less than 20 ppm can be achieved using conditions as shown in Table 4.

TABLE 4
Bromide concentrations in crystallizer
overflow containing 120 mM MgCl₂.

| Volume | | | | | Final bromide | |
|---|---|---|---|---|---|---|
| of | | | Added | Added | concentration | |
| brine | Added NaOCl | | MgCl₂ | NaOH | ppm | mg/l |
| 1000 ml | 7.75 | mmol | 120 mmol | 100 mmol | 120 | 146 |
| 1000 ml | 11.625 | mmol | 120 mmol | 100 mmol | 58 | 71 |
| 1000 ml | 15.5 | mmol | 120 mmol | 100 mmol | 11 | 13 |

As a result, the illustrated examples provide an embodiment of the method of the invention wherein bromide concentration in a brine solution can be selectively decreased. In particular, the experimental examples above show that in response to an optimal pH, as determined by adjusting NaOH concentration, the addition of hypochlorite and a divalent cation such as magnesium is effective to significantly reduce bromide concentration in a potassium chloride solution. By manipulating of pH, divalent cation concentration and the amount of oxidant used, bromide concentrations in the brine can be reduced from initial levels of 200-400 ppm (depending on whether raw feed brine or crystallizer overflow are used) to less than 100 ppm, and as low as 60 ppm or even less than 20 ppm. Using the method of the present invention, it has been possible to realize reductions in bromine concentration of as much as 97%.

Since it is expected that divalent metal cation-bromide precipitate will only form once all the reactants (e.g. Mg²⁺, OBr⁻ and OH⁻). Therefore, the process may be adapted to add the oxidant, divalent metal cation and OH in any order without reducing the effectiveness of bromide removal by the method. Thus, while in the examples magnesium has been added to the feed brine prior to the oxidation and precipitation steps, it is not considered that the order of addition is essential, and the addition of reactants in any order is considered to be within the scope of the invention as claimed.

Temperature Effect:

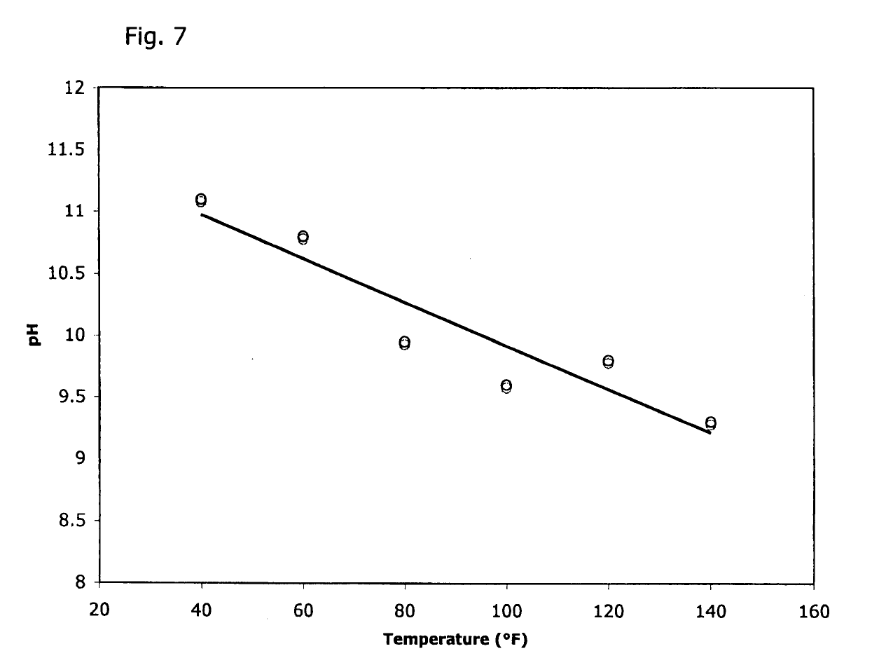

The effect of brine temperature with respect to the effectiveness of the process of removing bromide was also investigated. Experiments optimizing the method were performed at brine temperatures in the range from 40-140° F., and the method has been shown to be useable at temperatures as high as 180° F. As the results in FIG. 7 show, the pH optimum for bromide removal decreases as temperature of the brine solution was increased. Increasing the temperature of the brine to 140° F. resulted in a pH optimum that was 1.5 units lower than that observed at 40° F.

The knowledge that temperature affected the optimal pH for bromide removal using the method of the invention provides further advantages. Because different refining plants often carry out processing at various temperatures, these results provide a method of determining the optimal pH for the brine solution over a wide range of temperature. For example, a potassium chloride refining plant where the brines are maintained at 60° F. for various desirable operational reasons would use a pH optimum of around 10.8. In contrast, a different plant where brines might be processed at 100° F. for a different set of criteria would know to use a pH of 9.6 in order to most effectively remove bromide from the potassium chloride brine solution. In each case, both plants, using different conditions could achieve substantially the same quality of end product by using the information as present in FIG. 7.

This allows the present method of the invention to be readily adapted for use in a variety of refining sites, and provides the further advantage of simplifying the equipment required to carry out the process, as well as to avoid the added energy costs that occur when solutions are heated or cooled. Another advantage is that by reducing the optimum pH, approximately 25% less OH is required to achieve the same degree of bromide removal resulting in a further savings in terms of production costs.

Yet another advantage realized from the temperature effect on optimal pH is that as increased temperature and decreased pH optima are used, removal of bromide is more efficient. A shown in Table 5, when a temperature of 140° F. is used, residual bromide is around 0.08 gm/L. In contrast, when the process is carried out at 40° F. about 0.16 gm/L bromide remains in solution. Thus, where it would be desirable to have a potassium chloride product with as low as possible residual bromide, increasing the temperature of the brine during processing could be advantageously used to improve the efficiency of bromide removal.

Having described a method for reducing bromine levels in a potassium chloride brine solution, the present invention also provides for the manufacture of a potassium chloride product with reduced bromine content. Varying the amount of magnesium or the pH of the solution during the bromine removal process can be used to vary the extent to which bromine content is reduced in accordance with the method of the invention, such that potassium chloride products with a range of bromine contents are possible and are intended to be included within the scope of the invention.

Following removal of bromine from the potassium chloride solution using the method of the invention as described herein, it is then possible to recover potassium chloride in crystalline form. The methods for recovering potassium chloride from a solution are well known in the art and include, but are not limited to, the use of cooling ponds to differentially precipitate KCl while leaving NaCl remaining in solution. Another method of recovery for a KCl product involves the use of forced circulation evaporators and baffle tube crystallizers known to the art. In each case, the potassium chloride can be recovered and further processed as desired.

Given that the substitution rate of chloride by bromine in the crystal lattice of a potassium salt is approximately 0.6, the ultimate concentration of potassium bromide in a potassium chloride product will be approximately 0.6 times the concentration of bromine in the brine from which the potassium chloride product is made. As a result, by the method of the present invention, reduced-bromine potassium chloride products with bromine contents of less than 60 ppm, 30 ppm or even less than 15 ppm are achievable by varying the amounts of oxidant, divalent metal cation and pH of the feed brine, as described herein.

While it may be possible to further refine the method to produce even greater reductions, the types and extents of modifications in the method as described above are obvious to one skilled in the art, and the invention is intended to encompass all such modifications or variations with its scope. For example, other oxidants such as peroxides or calcium hypochlorite may be substituted for sodium hypochlorite. Conditions of temperature are also obvious choices as experimental variable when dealing with the solubility of inorganic salts. Process Design and Apparatus:

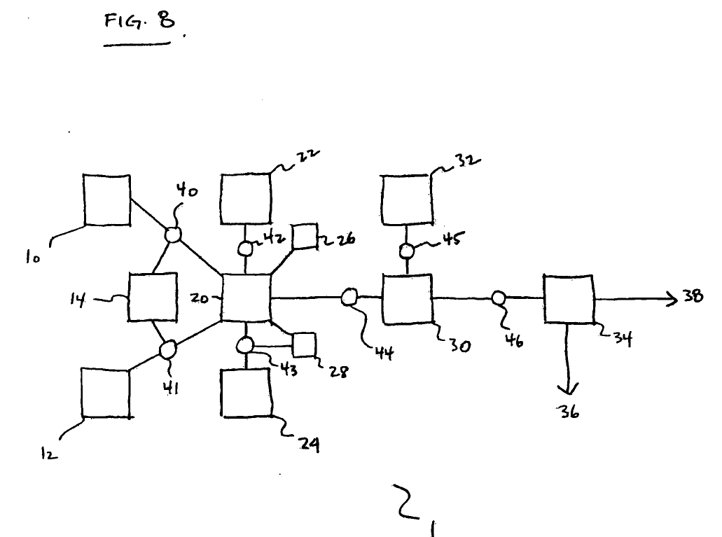

The invention further provides an apparatus for the production of bromine-reduced potassium chloride product. One embodiment of such an apparatus is provided in FIG. 8. An apparatus 1 for reducing bromide concentration in a potassium chloride feed brine solution comprises apparatus for the oxidation of the brine solution to convert bromine to hypobromite, precipitation of bromide as described in the experimental examples, and the separation of the bromide from the processed brine.

A potassium chloride feed brine solution 10 is mixed with a desired amount of a divalent cation from a divalent cation source 12 in a mixer 20. The ratio of potassium chloride feed brine solution and divalent cation are regulated by a feed brine flow regulator 40 and cation flow regulator 41 each under the control of a feed control unit 14. Conveniently magnesium is used as the divalent cation in the described embodiment, although other divalent metals such as calcium would be useable.

An oxidant source 22 provides an oxidant to the potassium chloride brine feedstock/divalent cation mixture in the mixer 20. The amount of oxidant added to the contents of the mixer 20 is regulated by an oxidant flow control unit 42. In one embodiment the oxidant is sodium hypochlorite, however in other embodiments it is possible to use other well know oxidants, for example ozone. The oxidant serves to convert bromine in the potassium chloride feed brine solution to hypobromite.

A temperature control system 26 senses and maintains the temperature of the contents of the mixer 20 at a desired temperature. Heating or cooling of the mixer 20 is accomplished using heat exchanger methods that are well known to those skilled in the art. Conveniently a temperature in the range from 40° F. to 180140° F. is selected as the desired temperature. Alternatively the temperature can simply be sensed, and adjustments to ingredients made based on the temperature of the brine, whatever that might be, thus reducing the cost of building and operating the apparatus.

After oxidation of the potassium chloride feed brine solution is substantially complete, hydroxide anion from a hydroxide source 24 is added to the mixer 20. A pH control system 28 functions to monitor the pH of the mixer contents, and to maintain the pH with a desired range by regulating the flow of hydroxide through a hydroxide flow control unit 43. The desired range would be a pH of 9-12. Other sources of hydroxide anion such as calcium hydroxide are adaptable to the apparatus as well, and their use is also contemplated by the invention.

The addition of hydroxide anion results in the formation of a bromide-containing precipitate. Once the bromide-containing precipitate forms, the contents of the mixer 20 are transferred to a stirring mixer 30. The transfer of the contents from the mixer 20 to the stirring mixer 30 is regulated by a transfer flow regulator 44. Conveniently the transfer flow regulator 44 could comprise a pump.

To the contents of the stirring mixer 30 is provided a flocculant from a flocculant source 32. The addition of flocculant is regulated by a flocculant control unit 45. The flocculant improves the efficiency of the precipitation process, thereby improving the overall effectiveness of the method of the present invention. When flocculants are used a convenient method of removal of the bromide-containing precipitate would be by flotation separation, or by sinking methods. There are a number of methods for separating precipitates from solutions that are well known in the art, and the invention is intended to encompass all such methods.

Once the precipitation process is essentially complete, the contents of the stirring mixer 30 are passed through a separator 34. The function of the separator 34 is to remove the bromide-containing precipitate 36 and to retain the remaining bromine-reduced brine solution 38 produced by the method of the invention. Conveniently the separator 34 may comprise a filter. Other methods of separation such as the use of a settling tank or a centrifuge are also contemplated to be within the scope of the claimed invention. A separator feed 46 moves the contents of the stirring mixer 30 through the separator 34. Conveniently, the separator feed may comprise a pump.

The bromine-reduced brine solution is then suitable for further processing to produce a bromine-reduced potassium chloride product. Further processing would comprise recovering a bromide-reduced granular potassium chloride product. Various methods are well known in the art that are suitable for converting a brine to a granular product, including differential precipitation, forced evaporation and baffle crystallization. The choice of processing method to convert the bromine-reduced brine solution products by the method of the invention in a granular potassium chloride product is not meant to be limiting in any way of the invention, and all suitable methods are intended to be within the scope of the invention.

The process may further comprise apparatus for heating or cooling and temperature monitoring and control equipment to maintain the process solution at a desired temperature.

Consequently, the foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A method of reducing bromide concentration in a feed brine solution, the method comprising:
performing an oxidation step comprising adding an amount of an oxidant effective to convert bromide to a bromide-containing compound that can precipitate out of the feed brine solution;
adding an amount of a metal cation effective to precipitate the bromide-containing compound;
adjusting the pH of the brine solution to an effective pH that favors precipitation of the bromide-containing compound as a bromide-containing precipitate;
removing the bromide-containing precipitate to yield a bromine-reduced brine solution.

2. The method of claim 1 wherein the feed brine solution is a raw potash feed brine obtained from a solution mining process.

3. The method of claim 1 wherein the feed brine solution is a crystallizer overflow solution obtained in the course of a potash refining process.

4. The method of claim 1 wherein the oxidation step comprises adding an amount of oxidant effective to convert substantially all of the bromide to the bromide-containing compound is between 1.5 and 3 molar parts oxidant to 1.0 molar part bromide.

5. The method of claim 4 wherein the oxidant is one of ozone, sodium hypochlorite, hydrogen peroxide, and calcium hypochlorite.

6. The method of claim 1 wherein the oxidation step comprises natural oxidation.

7. The method claim 6 wherein natural oxidation comprises aeration of the brine solution.

8. The method of claim 1 wherein the metal cation is one of magnesium, calcium, iron and manganese.

9. The method of claim 1 wherein the amount of the divalent metal cation effective to precipitate the bromide-containing compound is in the range of 1.0-1,000 millimolar (mM).

10. The method of claim 1 wherein the effective pH is in the range of 9-12 and wherein an optimal pH effective to precipitate a maximal amount of the bromide-containing compound varies with a temperature of the brine solution.

11. The method of claim 10 further comprising sensing the temperature of the brine solution and adjusting the pH to the optimal pH for a sensed temperature.

12. The method of claim 11 wherein the sensed temperature of the brine solution is in the range of 40° to 185° F.

13. The method of claim 10 wherein increasing the temperature lowers the optimal pH and increases the amount of bromide-containing precipitate formed.

14. The method of claim 13 wherein the temperature is increased to substantially 140° F. and wherein the optimal pH is between 9.0 and 9.5.

15. The method of claim 10 wherein the effective pH is achieved by the addition of an effective amount of a hydroxide anion.

16. The method of claim 15 wherein the effective amount of the hydroxide anion is in the range of 50-250 mM.

17. The method of claim 15 wherein the hydroxide anion is in the form of one of sodium hydroxide, calcium hydroxide and potassium hydroxide.

18. The method of claim 1 wherein removing the bromide-containing precipitate further comprises adding a flocculant.

19. The method of claim 18 further comprising flotation separation of the flocculant and bromide-containing precipitate.

20. The method of claim 1 wherein removing the bromide-containing precipitate comprises at least one of filtering, settling, centrifuging and hydrocyclone separation.

21. A bromine-reduced product produced by processing the brine of claim 1 and wherein the bromine content is less than 150 ppm.

22. The method of claim 21 wherein the bromine-reduced product is a bromine-reduced potassium chloride product

23. The product of claim 21 wherein the bromine content is less than 100 ppm.

24. The product of claim 23 wherein the bromine content is less than 50 ppm.

25. The product of claim 24 wherein the bromine content is less than 20 ppm.

26. The product of claim 21 wherein the processing of the brine is by differential precipitation.

27. The product of claim 21 wherein the processing of the brine is by one of forced evaporation, atmospheric drying and baffle crystallization.

28. A bromine-reduced potassium chloride product produced in a potash mining process wherein the bromine-reduced potassium chloride product comprises less than 150 ppm bromine.

29. The product of claim 28 wherein the bromine content of the bromine-reduced potassium chloride product is less than 100 ppm.

30. The product of claim 29 wherein the bromine content of the bromine-reduced potassium chloride product is less than 50 ppm.

31. The product of claim 30 wherein the bromine content of the bromine-reduced potassium chloride product is less than 20 ppm.

32. An apparatus for a process to produce a bromine-reduced brine solution, the apparatus comprising:
a means for adding an oxidant to the brine solution in a concentration effective to convert substantially all of the bromide in the feed brine to a bromide-containing compound that can precipitate out of the feed brine solution;
a means for adding a metal cation to a brine solution in a concentration effective to precipitate the bromide-containing compound as a bromide-containing precipitate
a pH sensing and control system to maintain the pH of the process at an effective pH that favors the precipitation of the bromide-containing compound by the metal cation; and
a means for removing the bromide-containing precipitate to yield a bromine-reduced brine solution.

33. The apparatus of claim 32 wherein the effective pH is within the range of 9-12 and wherein an optimal pH effective to precipitate a maximal amount of the bromide-containing compound varies with a temperature of the brine solution.

34. The apparatus of claim 33 further comprising a temperature sensor and wherein the pH is adjusted to the optimal pH for a sensed temperature.

35. The apparatus of claim 34 wherein the temperature of the brine solution is in the range of 40° to 185° F.

36. The apparatus of claim 35 wherein the means for removing the bromide-containing precipitate comprises a means for adding a flocculant.

37. The apparatus of claim 36 wherein the means for removing the bromide-containing precipitate comprises a means of flotation separation.

38. The apparatus of claim 37 wherein the means for removing the bromide-containing precipitate comprises at least one of a filter, a settling tank, a hydrocyclone and a centrifuge.

39. The apparatus of claim 38, further comprising a temperature control system to maintain the brine solution at a desired temperature.

40. The apparatus of claim 39 wherein increasing the temperature lowers the optimal pH and increases the amount of bromide-containing precipitate formed.

41. The apparatus of claim 40 wherein the temperature is increased to substantially 140° F. and wherein the optimal pH is between 9 and 9.5.
